(19) United States
(12) Patent Application Publication
(10) Pub. No.: US 2015/0022126 A1
(43) Pub. Date: Jan. 22, 2015

(54) METHOD AND APPARATUS FOR MONITORING A PERMANENT MAGNET ELECTRIC MACHINE

(71) Applicant: GM GLOBAL TECHNOLOGY OPERATIONS LLC, Detroit, MI (US)

(72) Inventors: STEVEN E. SCHULZ, TORRANCE, CA (US); KHWAJA M. RAHMAN, TROY, MI (US); WEI D. WANG, TROY, MI (US)

(21) Appl. No.: 13/945,356

(22) Filed: Jul. 18, 2013

(51) Int. Cl. H02P 21/00

(52) U.S. Cl. CPC H02P 21/0035
USPC 318/400.02

(57) ABSTRACT

A controller-implemented method for monitoring a permanent magnet electric machine includes determining a threshold direct-axis (d-axis) current corresponding to inception of irreversible demagnetization of the permanent magnet based upon material properties of a permanent magnet mounted in a rotor of the PM electric machine and a temperature of the permanent magnet. A d-axis current associated with controlling the PM electric machine is determined, and a state of health of the PM electric machine is determined based upon the threshold d-axis current and the monitored d-axis current.

### TECHNICAL FIELD

This disclosure is related to permanent magnet electric machines.

### BACKGROUND

The statements in this section merely provide background information related to the present disclosure. Accordingly, such statements are not intended to constitute an admission of prior art.

Electric machines include rotors that generate torque on a shaft in response to electromagnetic excitation from a stator. Electric machines can be configured as motor/generator devices that operate as motors to transform electrical energy to mechanical energy (torque) and operate as generators to transform mechanical energy (torque) to electrical energy. Permanent magnet electric machines generate torque on a shaft by the interaction of the electromagnetic field of the stator generated by exciting a stator element and the permanent magnet field of the rotor. Permanent magnets in the rotor can be mounted on the rotor surface (surface PM rotor) or buried inside the rotor (interior PM rotor). Permanent magnet electric machines provide a compact form having high torque density and low weight, with an ability to provide continuous torque over a wide range of speeds with low rotor inertia, high dynamic performance under load, high operational efficiencies with no magnetizing current, and the corresponding absence of heat due to current in the rotor.

One known fault that reduces service life of a permanent magnet electric machine is a loss of magnet flux due to demagnetization of rotor magnets. During machine fabrication, magnets are fully magnetized by saturating the magnet employing a high electromagnetic field. A magnet's strength, in part, is characterized by its remnant flux density. This is the flux density of the magnet when two ends of the magnet are shorted by an infinitely permeable material. Magnet strength is selected to meet certain performance characteristics of the electric machine including a desired maximum torque. Magnet flux can remain relatively unchanged over the life of the electric machine unless the magnet is subjected to excessive thermal and other demagnetization stresses. There is temperature dependence for the magnet remnant flux, but the effect can be accounted for in system design and is fully recoverable so long as a knee of the demagnetization (BH) curve is not reached or exceeded. A magnet can suffer irreversible loss of flux or demagnetization if subjected to excess thermal and magnetic stresses. The loss of flux negatively affects machine performance and behavior. Degraded machine behavior may lead to a fault on the vehicle that may be difficult to diagnose and isolate.

### SUMMARY

A controller-implemented method for monitoring a permanent magnet electric machine includes determining a threshold direct-axis (d-axis) current corresponding to inception of irreversible demagnetization of the permanent magnet based upon material properties of a permanent magnet mounted in a rotor of the PM electric machine and a temperature of the permanent magnet. A d-axis current associated with controlling the PM electric machine is determined, and a state of health of the PM electric machine is determined based upon the threshold d-axis current and the monitored d-axis current.

### BRIEF DESCRIPTION OF THE DRAWINGS

One or more embodiments will now be described, by way of example, with reference to the accompanying drawings, in which:

FIG. 1 illustrates an end view of a portion of a permanent magnet electric machine and associated circuitry, in accordance with the disclosure;

FIG. 2 illustrates a demagnetization curve for an embodiment of a magnet fabricated from NdFeB-type magnet material, with field intensity H(A/m) shown in relation to flux density B(T), in accordance with the disclosure;

FIG. 3 illustrates a calibration set for determining a minimum allowable d-axis current for the PM electric machine based upon temperature of the permanent magnet, in accordance with the disclosure;

FIG. 4 illustrates a Fast Task portion of an embodiment of a state of health control routine for evaluating a magnet for a PM electric machine during ongoing operation, in accordance with the disclosure;

FIG. 5 illustrates a Slow Task portion of the SOH control routine for evaluating a state of health of a magnet for a permanent magnet electric machine during ongoing operation, in accordance with the disclosure; and

FIG. 6 illustrates an exemplary figure of merit array including a plurality of temperature bins with corresponding figure of merit values to track the figure of merit value in relation to the magnet temperature, in accordance with the disclosure.

### DETAILED DESCRIPTION

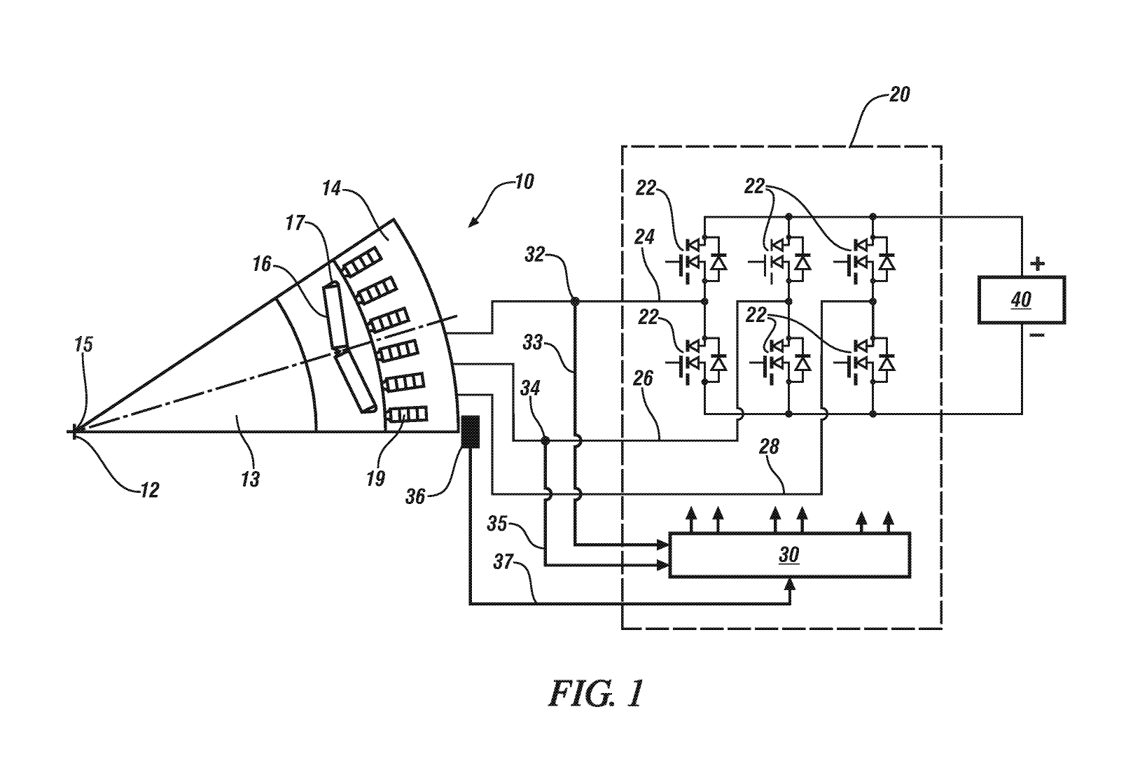

Referring now to the drawings, wherein the showings are for the purpose of illustrating certain exemplary embodiments only and not for the purpose of limiting the same, FIG. 1 schematically illustrates an end view of a section of an exemplary permanent magnet (PM) electric machine 10 and associated circuitry. The permanent magnet electric machine 10 includes a motor case including end caps and bearings, which provide a housing and structural support for an inner rotor 13 and an outer distributed stator 14. The rotor 13 rotates about an axis of rotation 12, and includes a plurality of permanent magnets 16 that are inserted into openings 17 near an outer circumferential surface of the rotor 13, referred to as interior permanent magnet (IPM) devices. Other embodiments of PM machines may be employed, including PM machines employing an inside-out construction or an axial flux design.

The permanent magnets 16 can be fabricated from any suitable magnet materials, such as ferrite or rare earths including, e.g., Neodymium Iron Boron (NdFeB). The stator 14 includes a plurality of coil elements 19 that are oriented about an outer circumference of the rotor 13 and interact with the permanent magnets 16. The circuitry includes an inverter 20 that electrically connects to the coil elements 19 and transforms DC voltage originating from a high-voltage DC power source 40 to AC voltage to energize the coil elements 19, which interact with the permanent magnets 16 to produce torque in the rotor 13 in response to control signals originating in a controller 30. In one embodiment, the inverter 20 is a three-phase device employing a plurality of paired gate drive switches 22, e.g., IGBTs that electrically connect via electrical cables 24, 26, 28 to individual ones of the coil elements 19, with electric power monitored via current sensors 32 and 34 that are electrically connected to the controller 30 via cables 33 and 35, respectively. A rotational position/speed sensor 36 is employed to monitor position/speed of the rotor 13 and signally connects to the controller 30. Preferably the electrical current supplied from the inverter 20 to energize the coil elements 19 is sinusoidal, with each phase continuously excited with varying amplitudes. The controller 30 is configured to execute control routines to control operation of the inverter 20 and to monitor operation of the PM electric machine 10, including monitoring position/speed of the rotor 13, monitoring electrical current to the PM electric machine 10, monitoring or otherwise determining temperature of the rotor 13 and/or permanent magnets 16, and executing a control routine to evaluate a state of health of the permanent magnets 16 during ongoing operation.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, control routines, code, algorithms and similar terms mean any instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 100 microseconds and 3.125, 6.25, 12.5, 25 and 100 milliseconds during ongoing engine and vehicle operation. Alternatively, routines may be executed in response to occurrence of an event.

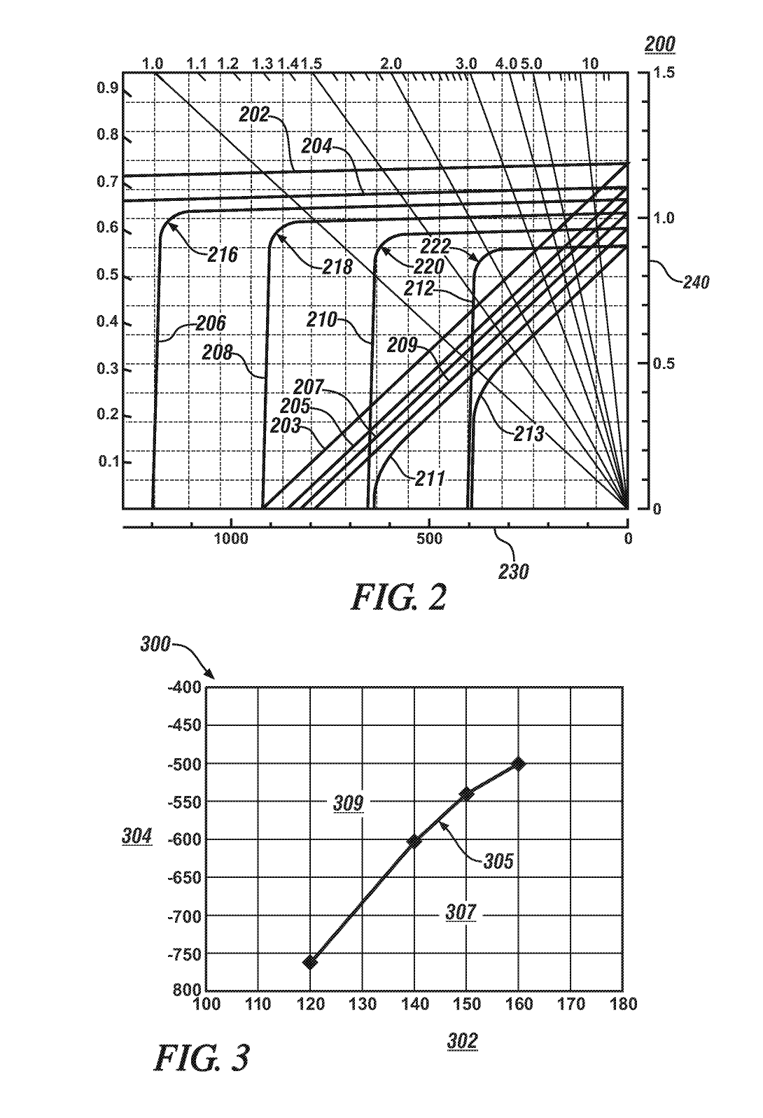

FIG. 2 graphically shows representative curves in a de-magnetization quadrant (or BH) 200 for an embodiment of a magnet fabricated from NdFeB-type magnet material, with field intensity −H (kA/m) 230 on the horizontal x-axis in relation to flux density B (T) 240 on the vertical y-axis. Intrinsic and normal curves for field intensity in relation to flux density are plotted for a plurality of magnet temperatures. This includes intrinsic curves 202, 204, 206, 208, 210 and 212 for magnet temperatures of 20° C., 110° C., 140° C., 170° C., 200° C., and 230° C., respectively, and normal curves 203, 205, 207, 209, 211 and 213 for magnet temperatures of 20° C., 110° C., 140° C., 170° C., 200° C., and 230° C., respectively. Each of the normal curves represents a measured, combined B value of an applied magnetic field and a field contributed by the permanent magnet. Each of the intrinsic curves represents a calculated output due only to the magnet. The y-intercept for zero field intensity (H) is referred to as a remnant flux density Br. As shown, the intrinsic curves 206, 208, 210 and 212 each includes a sharp knee 216, 218, 220 and 222, respectively, indicating a temperature-related demagnetization knee. A magnet that is subjected to operating conditions wherein the field intensity H is pushed beyond the demagnetization knee associated with the magnet temperature will not return on the same curve when the field intensity H is removed from the magnet. Instead, a magnet that is exposed to such conditions can suffer demagnetization that may be irreversible and unrecoverable, including reducing the remnant flux density. In one embodiment, the field intensity H can be pushed beyond the demagnetization knee due to a large externally applied field such as a large demagnetizing current. The remnant flux density increases as the magnet temperature gets colder. This applies to both ferrite and rare earth NdFeB-type magnets. This effect is characterized by a reversible temperature coefficient of induction a (%/° C.). The knee of the curve and intrinsic coercivity also move as a function of temperature. The intrinsic coercivity is defined by the intrinsic BH curve which can be obtained by adding −μ₀H to the respective normal curve where the permeability of the free space is μ₀. The horizontal x-axis crossing for zero flux of the intrinsic BH curve is referred to as the intrinsic coercivity. The temperature effect on the intrinsic coercivity H_{ci} is characterized by a reversible temperature coefficient of coercivity β in %/° C. For NdFeB-type magnets, the β is negative, and H_{ci} moves to the left, i.e., increases in absolute intensity, as the temperature of the NdFeB magnet temperature decreases. Thus, an NdFeB magnet can tolerate a larger externally applied field without damage at lower temperatures as compared to higher temperatures. Magnets fabricated from NdFeB have negative values for both α and β. Ferrite magnets also have negative values for α. However, ferrite magnets are ferri-magnetic, not ferro-magnetic and exhibit a positive value for β. This makes ferrite magnets resistant to demagnetization at high temperatures, but more susceptible to demagnetization at lower temperatures e.g., at −40° C. Representative curves in a de-magnetization quadrant can be developed and employed for embodiments of magnets fabricated from other magnet materials.

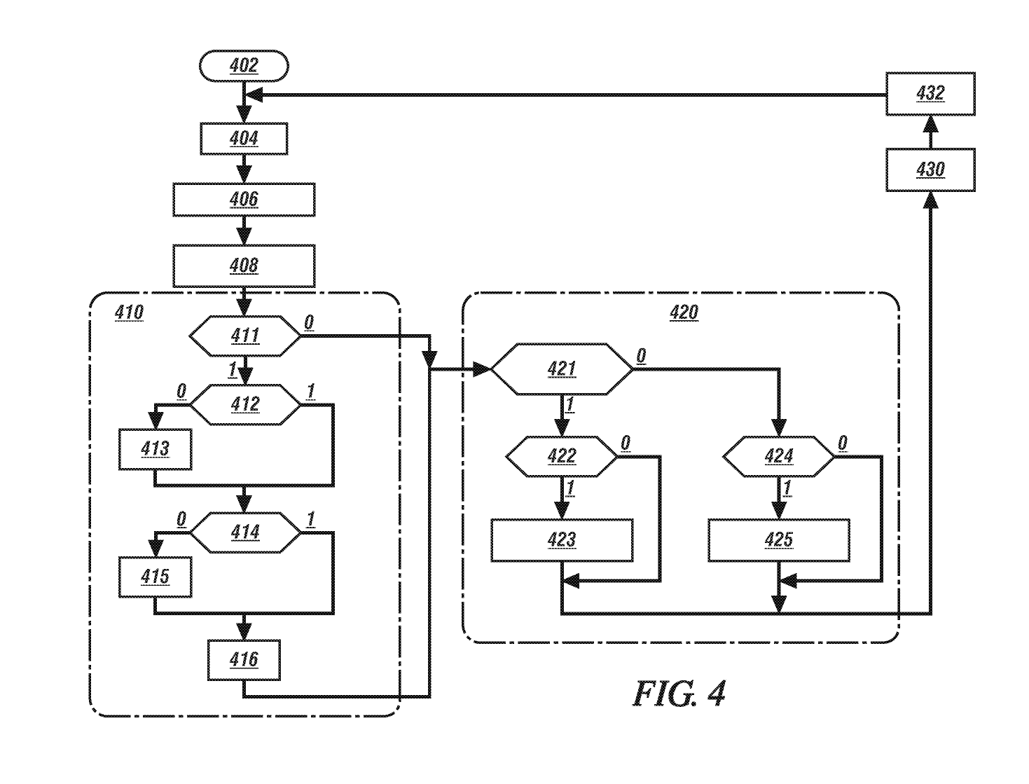

FIG. 3 graphically shows magnet temperature (° C.) on the horizontal x-axis 302 and peak direct axis (d-axis) current (Apk) on the vertical y-axis 304, with a minimum allowable d-axis current line 305 plotted thereon, and shows an embodiment of a calibration set 300 for determining a minimum allowable d-axis current for the permanent magnet based upon temperature of the permanent magnet. The minimum allowable d-axis current line 305 is based upon an evaluation of the d-axis current as a negative value. Thus, the minimum allowable d-axis current line 305 is employed to circumscribe operation at d-axis currents that are more negative. The magnet temperature measurement or estimate is accurate with some allowance for error, e.g., +/−10C. Demagnetization curves analogous to the intrinsic curves shown with regard to FIG. 2 are very steep at temperatures to the left of the knee. Thus, the magnitude of demagnetization is sensitive to temperature errors near the knee. Area 309 represents operating points of rotor temperatures and related d-axis currents at which there is no risk of demagnetizing the magnet. Area 307 represents operating points of rotor temperatures and related d-axis currents at which the magnet demagnetizes. The minimum allowable d-axis current line 305 can be reduced to a calibration array or another suitable form and employed to determine a magnitude for the minimum allowable d-axis current for the permanent magnet based upon the temperature of the permanent magnet. The minimum allowable d-axis current line 305 can be developed using finite element analysis on an embodiment of the machine structure for various magnet temperatures and current stress levels, and indicates for each temperature a magnitude of d-axis current that will start to demagnetize at least a portion of the magnet. Operating conditions can be encountered which result in operating states that approach or exceed the knee of the curve and demagnetize the magnet. Such operating states include system faults and system overload events.

The representative curves shown with reference to FIG. 2 indicate that demagnetization of a magnet is a function of temperature and the externally applied field, more specifically a negative d-axis current. A DQ transform is a known mathematical transformation that can be employed to simplify analysis of three-phase circuits. In the case of balanced three-phase circuits, application of a DQ transform reduces the three AC quantities to two DC quantities, including a d-axis current component and a quadrature-axis (q-axis) current component. Simplified calculations can then be carried out on the dq DC quantities followed by an inverse transform to recover actual three-phase AC quantities.

A PM electric machine employing dq vector control includes the d-axis assigned to align with the rotor magnet north pole, and a positive d-axis current tends to increase or assist the magnet flux. Alternatively, a negative d-axis current tends to oppose the magnet flux. It is the negative d-axis current that causes the external field to oppose the magnet flux, and pushes the magnet to the left along the demagnetization curve. When sufficient negative d-axis current is applied and the knee of the BH curve is reached or exceeded, the magnet can be damaged and suffer irreversible loss of flux. Rotor position information is required to determine the dq reference frame quantities.

A state-of-health (SOH) control routine is a control routine for operating a PM electric machine that includes determining and tracking a SOH of the rotor magnet in real-time. The information can be continuously updated and stored in non-volatile memory for the life of the electric machine. The data can be used by service personnel to help isolate potentially damaged machines. Furthermore, application-specific information related to SOH of the rotor magnet can be employed to optimize system calibrations in order to identify and avoid operating conditions that can cause demagnetization. Additionally, certain machine control routines may benefit from having knowledge of the SOH of the rotor magnet. This can include control routines configured to monitor SOH of the rotor magnet and avoid electric machine operating states at which the rotor magnet is near the knee of the curve to avoid demagnetizing the rotor magnet. Such electric machine operating states can include derating torque output of the PM electric machine to avoid externally applied fields in the form of torque commands that include d-axis current commands associated with operation of the rotor magnet near the knee of the curve to avoid a demagnetizing current.

The SOH control routine includes monitoring operating parameters of magnet temperature and a d-axis current during ongoing operation of the electric machine. The SOH control routine includes a Fast Task 402 and a Slow Task 440. Monitored operating parameters preferably include magnet temperature, d-axis current in the PM electric machine, and rotational position of the rotor, which is employed to evaluate d-axis current. The magnet temperature can be obtained employing either a physical sensor or by suitable estimation. Estimation can include equating or otherwise modeling the magnet temperature based upon the temperature of the rotor of the PM electric machine. Temperature of the magnet changes relatively slowly, often with a time constant in the range of seconds. In contrast, the d-axis current can change in less than a millisecond. In operation, the SOH control routine periodically executes the Fast Task 402 at a cycle period that permits monitoring the d-axis current at a rate that is sufficient to capture dynamics in the d-axis current that may result in damage to the magnet(s) during ongoing operation. Thus, the d-axis current is preferably monitored at a relatively higher rate, e.g., 100 microseconds, and the magnet temperature is preferably monitored at a relatively slower rate, e.g., on the order of magnitude of 100 milliseconds in order to minimize unnecessary loading of a processor executing the SOH control routine. A SOH for the permanent magnet is determined based upon the monitored operating parameters of the permanent magnet, such as the d-axis current at the magnet temperature, taking into account known characteristics for the permanent magnet. Operation of the PM electric machine can be controlled based upon the state of health of the permanent magnet.

The SOH control routine relies on the monitored d-axis current to determine the SOH figure of merit (FOM). This requires both valid current and rotational position measurement information, i.e., the sensors must be functional. If a fault related to either the current or position sensor occurs, the d-axis current information is no longer valid and the SOH FOM cannot be determined with confidence. When a current sensor fault occurs, it is not possible to update the SOH FOM at all. However a compromise approach can be taken for a fault in the position sensor resulting in degraded but usable temperature information.

During normal operation, the FOM-max and FOM array will be updated. However, in the event that either d-axis current or temperature data are uncertain, an alternate low confidence FOM-max is updated instead. For example, in the event of a position sensor failure, the synchronous frame quantities such as d-axis current cannot be determined Instead, the total stator current vector amplitude can be computed from the stationary frame currents. The current vector can be assumed to be aligned to the worst case angle for demagnetization (i.e., negative d-axis) for calculation of the low confidence FOM. In other situations, the rotor temperature information may be degraded but still usable. In this case only the low confidence FOM is updated. The low confidence FOM value is recognized to be conservative in nature, and merely implies the possibility that electrical/thermal stress might have been applied to the magnets of the PM electric machine.

FIG. 4 schematically shows an embodiment of the Fast Task portion 402 for evaluating a state of health of an embodiment of a magnet for a PM electric machine during ongoing operation, taking into account specific characteristics of the magnet material and motor operating conditions. Table 1 is provided as a key to FIG. 4 wherein the numerically labeled blocks and the corresponding functions are set forth as follows.

TABLE 1

| BLOCK | BLOCK CONTENTS |
|---|---|
| 402 | Fast Task |
| 404 | Monitor phase currents |
| 406 | Transform phase currents to synchronous (dq) reference |
| | frame |
| 408 | Calculate total stator current vector (Is) |
| 410 | Reset Data |
| 411 | Is data capture complete? |
| 412 | Is Id-min < Captured Id-min? |
| 413 | Set Id-min = 0 |
| 414 | Is Is-max > Captured Is-max? |
| 415 | Is-max = 0 |
| 416 | Set data capture complete FALSE |
| 420 | Update Data |
| 421 | Is position information valid? |
| 422 | Is Id < Id-min? |
| 423 | Set Id-min = Id |
| 424 | Is Is > Is-max |
| 425 | Set Is-max = Is |
| 430 | Execute other algorithms |
| 432 | End iteration; wait for next iteration |

The Fast Task 402 includes monitoring phase currents associated with the electric machine (404), transforming the phase currents to the synchronous (dq) reference frame (406), and calculating a total stator current vector Is using known abc-dq vector transformation equations (408). This calculation of the total stator current vector Is allows for execution of a backup process to evaluate the state of health of the magnet for PM electric machine, e.g., when a fault occurs that affects the dq vector transformation, such as a fault in sensor position/speed monitoring.

A subroutine is executed to reset data (410), which includes initially determining that data capture is complete (411). When the data capture is complete (411)(1), it is determined whether the minimum d-axis current component (Id-min) is less than a previously captured d-axis current component (412). If not (412)(0), the minimum d-axis current component is set equal to zero (Id-min=0) (413) and operation continues. If so (412)(1), the minimum d-axis current component is unchanged. It is next determined whether the maximum total stator current vector (Is-max) is greater than a previously captured maximum total stator current vector (Captured Is-max) (414). If not (414)(0), the maximum total stator current vector (Is-max) is set equal to zero (415). If so (414)(1), the maximum total stator current vector (Is-max) is unchanged. The data capture flag is set to FALSE (416), and operation continues to update the data (420). When the data capture is not complete (411)(0), the operation continues.

A subroutine is executed to update the data (420) that includes verifying that rotational position of the rotor is valid (421), and if so (421)(1), comparing the direct-axis current component (Id) to a minimum direct-axis current component (Id-min) (422). When the direct-axis current component (Id) is less than the minimum direct-axis current component (Id-min) (422)(1), the minimum direct-axis current component (Id-min) is set equal to the direct-axis current component (Id) (423). Otherwise (422)(0), the minimum direct-axis current component (Id-min) remains unchanged. When the position information is invalid (421)(0), the total stator current vector (Is) is compared to a maximum total stator current vector (Is-max) (424). When the total stator current vector (Is) is greater than the maximum total stator current vector (Is-max) (424)(1), the maximum total stator current vector (Is-max) is set equal to the total stator current vector (Is) (425). Otherwise (424)(0), the maximum total stator current vector (Is-max) remains unchanged. Other algorithms may then execute (430), and the present iteration of the Fast Task 402 ends (432), awaiting execution of the next iteration.

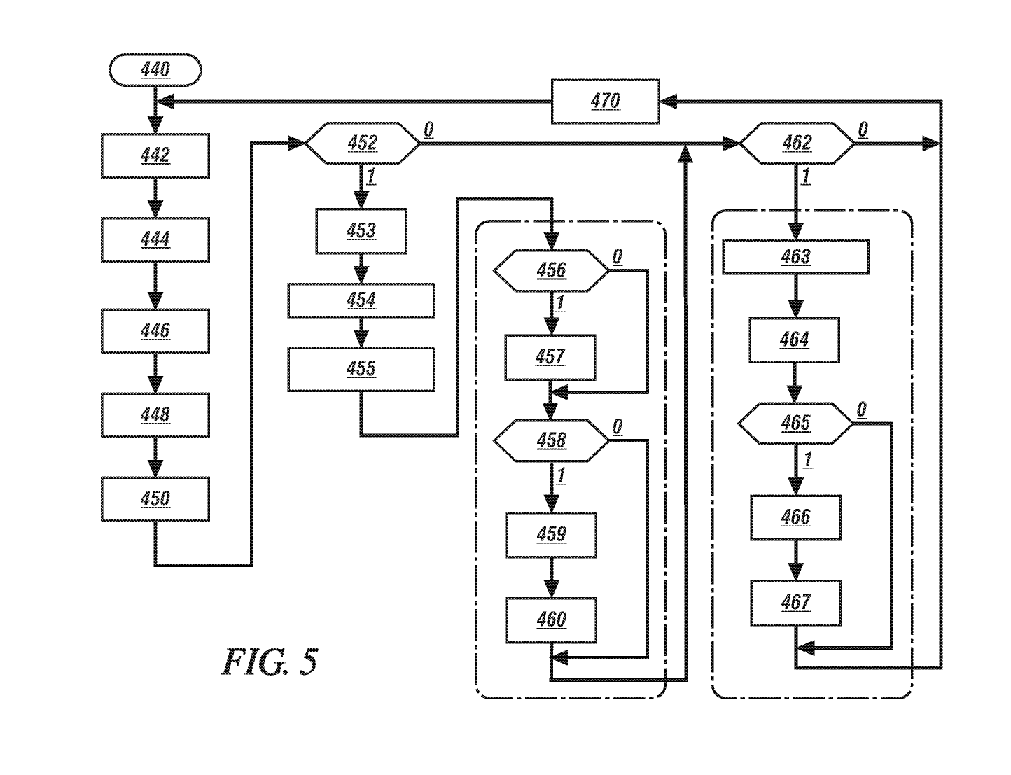

FIG. 5 shows an embodiment of the Slow Task portion 440 of the SOH control routine for evaluating a state of health of a magnet for a PM electric machine during ongoing operation. The Slow Task 440 executes coincident with the Fast Task 402 at a cycle period that permits monitoring the magnet temperature at a rate that is sufficient to track the expected dynamics in the magnet temperature. In one embodiment the Slow Task 440 executes each 100 milliseconds. Table 2 is provided as a key to FIG. 5 wherein the numerically labeled blocks and the corresponding functions of the Slow Task 440 are set forth as follows.

TABLE 2

| BLOCK | BLOCK CONTENTS |
|---|---|
| 440 | Slow Task |
| 442 | Capture Id-min from Fast Task; Store as Id-min-cap |
| 444 | Capture Is-max from Fast Task; Store as Is-max-cap |
| 446 | Set date capture flag to TRUE |
| 448 | Determine and update magnet temperature (Trotor) |
| 450 | Determine Id-knee as function of magnet temperature |
| 452 | Is Id-min-cap < 0 and is Trotor valid? |
| 453 | Calculate FOM-new |
| 454 | Limit FOM-new ≧ 0 |
| 455 | Determine temperature window for FOM array |
| 456 | Is FOM-new > Array value for temperature window |
| 457 | Update FOM Array for temperature window |
| 458 | Is FOM-new greater than FOM-max? |
| 459 | Update FOM-max |
| 460 | Store Speed, Vdc, and temperature for FOM-max |
| 462 | Is Is-max-cap > 0? OR |
| | Is Trotor degraded? |
| 463 | Set Ix = min(Id-min-cap, -Is-max-cap) |
| 464 | Determine FOM-new based upon Ix, Id-knee |
| 465 | Is FOM-new> FOM-low-conf? |
| 466 | Update FOM-low-conf |
| 467 | Store Speed, Vdc, and temperature for FOM-low-conf |
| 470 | Evaluate FOM-new; |
| | Control operation based upon FOM-new |
| | End iteration |

Execution of the Slow Task 440 includes as follows. The minimum direct-axis current component (Id-min) from the Fast Task 402 and the maximum total stator current vector (Is-max) from the Fast Task 402 are captured and stored (Id-min-cap and Is-max-cap, respectively) for subsequent use (442, 444), and a data capture complete flag is set (=TRUE) to indicate the steps are complete (446). Temperature of the magnet (Trotor) is determined (448) either by direct temperature measurement or another suitable predictive or estimation process. The temperature signal has an associated status which can be valid, degraded, or invalid. If the temperature determination function is operating normally, the data can be considered valid. In some cases, a rotor temperature can be determined with an increased level of error. In these cases the rotor temperature can be identified as degraded. In other cases it may not be possible to determine the rotor temperature at all due to a sensor fault. In this case, the rotor temperature signal can be identified as invalid. For degraded rotor temperature, only the low confidence FOM is updated. For invalid temperature, the demagnetization characteristics cannot be determined and the FOM data is not updated. A demagnetization knee (Id-knee) can be determined in relation to the temperature of the magnet (450) employing representative curves from a de-magnetization quadrant for the embodiment of the magnet, and represents a parameter associated with intrinsic coercivity for the permanent magnet of the PM electric machine that is based upon properties of the material from which the permanent magnet is fabricated. The representative curves are analogous to those shown herein with reference to FIG. 2.

The minimum direct-axis current component (Id-min-cap) and the magnet temperature (Trotor) are evaluated (452). When the minimum direct-axis current component (Id-min-cap) is a negative value (<0) and the magnet temperature (Trotor) is valid (452)(1), a new figure of merit (FOM-new) for the state of health (SOH) of the permanent magnet can be determined (453) as follows.

$$\begin{matrix}FOM - new = \frac{\text{Id-min-cap}}{\text{Id-knee}} & [ 1 ] \\ & \end{matrix}$$

wherein
Id-min-cap is the minimum measured d-axis current during a previous sample window, and
Id-knee is the temperature-related demagnetization knee, which is determined based upon the minimum allowable d-axis current line 305 and the magnet temperature, e.g., as shown and described with reference to FIG. 3.

When the calculated FOM (FOM-new) is less than 1.0, it suggests that the temperature/electric-induced demagnetization stress to the magnets is within acceptable limits and that the magnets are likely functional. When the new figure of merit (FOM-new) is greater than 1.0, it suggests that there has been sufficient temperature/electrical stress to effect some level of demagnetization of the magnets. The magnitude of the calculated ratio of the new figure of merit (FOM-new) provides information about the magnitude of the actual stresses in relation to the maximum allowable value. This operation is repeated every execution of the Slow Task 440. For successive iterations of the Slow Task 440, the maximum ratio, i.e., a ratio of measured and allowable d-axis currents is tracked and stored. When the FOM is greater than 1.0, the magnitude of demagnetization increases with increase in the FOM. When the FOM is less than 1.0, the risk of demagnetization increases with an increase in the FOM. The minimum d-axis current value is reset every execution of the Slow Task 440.

The new figure of merit (FOM-new) is limited to a positive value (Limit FOM-new≧0) (454), and inserted into an appropriate temperature bin of a FOM array by associating the temperature of the permanent magnet with a temperature window corresponding to a temperature bin (455), comparing the new figure of merit (FOM-new) with the present contents of the temperature bin for the FOM array (456) and updating the contents of the temperature bin for the FOM array (457) when the new figure of merit (FOM-new) is greater than the present contents (456)(1). The new figure of merit (FOM-new) is also compared with a maximum stored FOM (FOM-max) (458). The maximum stored FOM (FOM-max) is updated with the new figure of merit (FOM-new) (459) when the new figure of merit is greater (458)(1). Motor operating conditions associated with the new figure of merit, including rotational speed, temperature, electrical current and DC voltage are also captured (460), and operation continues.

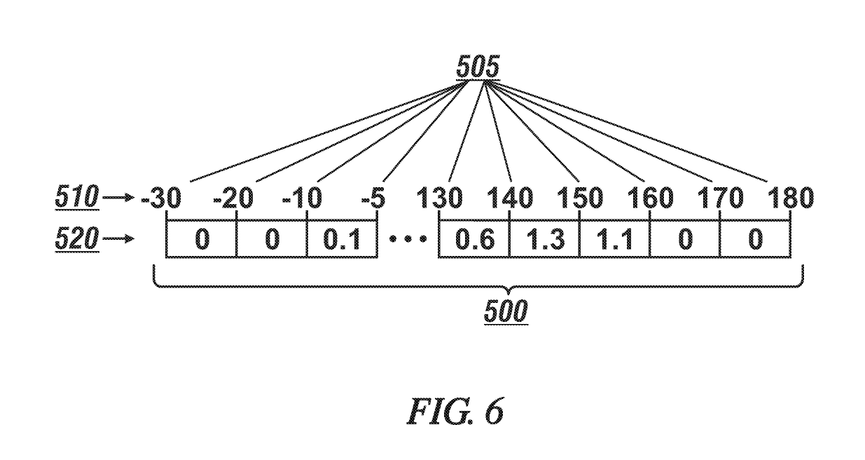

FIG. 6 shows an exemplary FOM array 500 including a plurality of temperature bins 505 shown at 510 with corresponding FOM values shown at 520. The FOM array 500 is established to track the FOM value in relation to the temperature of the permanent magnet. The FOM array 500 has an overall temperature range between −30° C. and +170° C. and each of the temperature bins 505 is associated with a 10° C. temperature window, e.g., −30° C. to −20° C., −20° C. to −10° C., etc, in one embodiment. A FOM value is calculated for each iteration of the Slow Task 440. In this manner, one can track how the stresses to the PM electric machine vary depending upon operating conditions.

Referring again to FIG. 5, when either the minimum direct-axis current component (Id-min-cap) is a non-negative value (i.e., ≧0) or the magnet temperature (Trotor) is not valid (452)(0), or the aforementioned conditions have been met (452)(1) and the new figure of merit (FOM-new) has been calculated and evaluated for updating the FOM array and FOM-max (steps 453-460), the maximum total stator current vector (Is-max-cap) from the Fast Task 402 and the magnet temperature (Trotor) are evaluated (462). When either the maximum total stator current vector (Is-max-cap) is greater than zero or the magnet temperature (Trotor) has degraded (462)(1), a low confidence FOM is calculated by selecting a minimum of the measured d-axis current (Id-min-cap) and a negative value of the maximum total stator current vector (−Is-max-cap) (463) and employing the selected minimum to calculate the new figure of merit (FOM-new), which is a low confidence FOM for the state of health (SOH) of the permanent magnet (464) as follows.

$$FOM - new = \frac{Ix}{\text{Id-knee}} \qquad [ 2 ]$$

wherein
Ix is the minimum of the measured d-axis current (Id-min-cap) and the negative value of the maximum total stator current vector (−Is-max-cap), and
Id-knee is the temperature-related demagnetization knee, which is the minimum allowable d-axis current for the temperature of the magnet, which is determined based upon the minimum allowable d-axis current line 305 and the rotor temperature, e.g., as shown and described with reference to FIG. 3.

The calculated FOM (FOM-new) is compared with a low confidence FOM (FOM-low-conf) (465) and the low confidence FOM is updated to equal the calculated FOM (466) when the calculated FOM is greater than the low confidence FOM (466)(1). Motor operating conditions associated with the new FOM, including rotational speed, temperature, electrical current and DC voltage are also captured (467), and operation continues. The calculated FOM and associated rotational speed, temperature, electrical current and DC voltage are preferably captured for use by service personnel seeking to identify a root cause to an electric machine-related fault.

When the maximum total stator current vector (Is-max-cap) is less than zero and the magnet temperature (Trotor) has not degraded (462)(0), or the low confidence FOM (FOM-low-conf) is confirmed or updated (Steps 463-467), this iteration of the Slow Task 440 ends, and includes evaluating the new figure of merit and/or the low confidence FOM, and controlling operation of the PM electric machine based thereon (470). This can include no action, e.g., when the new figure of merit and/or the low confidence FOM have low value, i.e., <1.0. This can include derating torque output of the PM electric machine when the new figure of merit and/or the low confidence FOM have relatively high value, i.e., ≧1.0. The FOM array can be evaluated, including determining whether the SOH FOM value in any of the bins 505 of the SOH FOM array is greater than the allowable SOH FOM, and if so, derating machine performance or otherwise limiting operation of the system. Such information can be employed in setting up temperature derate calibrations.

Alternatively, the Slow Task 440 can employ a 2-dimensional look-up table to store a normalized magnet flux that is based upon demagnetization characteristics of the machine. The normalized magnet flux has a value between 0 and 1, wherein 1 indicates a motor having magnets that are fully magnetized without degradation, and 0 indicates magnets that are fully demagnetized and exhibit zero flux. The table inputs are d-axis current (signed) and magnet temperature. The output of the table is a normalized magnet flux value. The algorithm uses the magnet temperature and minimum d-axis current to index into the table and return the normalized magnet flux during each iteration of the Slow Task 440. Over subsequent Slow Tasks, the minimum normalized magnet flux value is tracked and stored as the FOM.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for monitoring a permanent magnet (PM) electric machine, comprising
determining a threshold direct-axis (d-axis) current corresponding to inception of irreversible demagnetization of the permanent magnet based upon material properties of a permanent magnet mounted in a rotor of the PM electric machine and a temperature of the permanent magnet;
monitoring a d-axis current associated with controlling the PM electric machine; and
determining a state of health of the PM electric machine based upon the threshold d-axis current and the monitored d-axis current.

2. The method of claim 1, wherein monitoring the d-axis current associated with controlling the PM electric machine comprises:
monitoring the d-axis current at a monitoring rate sufficient to capture dynamics in the d-axis current that may result in damage to the permanent magnet; and
determining a minimum value for the d-axis current.

3. The method of claim 2, wherein monitoring the d-axis current at a monitoring rate sufficient to capture dynamics in the d-axis current that may result in damage to the permanent magnet comprises monitoring the d-axis current at no less than a 100 microsecond sampling rate.

4. The method of claim 1, wherein determining the state of health of the PM electric machine based upon the threshold d-axis current and the monitored d-axis current comprises determining a figure of merit (FOM) in accordance with the following relationship:
$$FOM = \frac{\text{Id-min}}{\text{Id-knee}}$$
wherein
Id-min is a minimum magnitude for the d-axis current, and
Id-knee is a minimum allowable d-axis current determined based upon the material properties of the permanent magnet.

5. The method of claim 4, wherein the minimum allowable d-axis current comprises a temperature-related demagnetization current knee determined based upon an intrinsic coercivity for the permanent magnet of the PM electric machine and the temperature of the permanent magnet.

6. The method of claim 4, wherein determining the figure of merit (FOM) in accordance with the relationship
$$FOM = \frac{\text{Id-min}}{\text{Id-knee}}$$
comprises determining the minimum magnitude for the d-axis current at a monitoring rate sufficient to capture dynamics in the d-axis current that may demagnetize the permanent magnet and determining the temperature-related demagnetization current knee at a monitoring rate that is sufficient to track expected dynamics in the permanent magnet temperature.

7. The method of claim 1, further comprising controlling operation of the PM electric machine based upon the state of health of the PM electric machine.

8. The method of claim 7, wherein controlling operation of the PM electric machine based upon the state of health of the PM electric machine comprises derating torque output of the PM electric machine.

9. The method of claim 1, further comprising:
generating a temperature-based array comprising a plurality of temperature bins associated with a plurality of temperature windows of the permanent magnet; and
determining a state of health of the PM electric machine associated with one of the temperature bins based upon the monitored d-axis current, the temperature of the permanent magnet, and a magnet temperature corresponding to inception of irreversible demagnetization of the permanent magnet based upon material properties of the permanent magnet and a temperature of the permanent magnet.

10. The method of claim 1, further comprising:
determining a maximum total stator current vector amplitude during periods when rotor position information is not available;
determining a low-confidence figure of merit (FOM) for evaluating the state of health of the PM electric machine in accordance with the following relationship:
$$FOM = \frac{Ix}{\text{Id-knee}}$$
wherein
Ix is a negative of the maximum total stator current vector amplitude, and
Id-knee is a minimum allowable d-axis current determined based upon the permanent magnet temperature.

11. A method for monitoring a permanent magnet (PM) electric machine, comprising:
determining a temperature-based demagnetization knee for a permanent magnet of the PM electric machine based upon material properties of the permanent magnet and a temperature of the permanent magnet;
determining a direct-axis (d-axis) current associated with controlling the PM electric machine; and
determining a state of health of the PM electric machine based upon the temperature-based demagnetization knee for the permanent magnet of the PM electric machine and the d-axis current.

12. The method of claim 11, wherein determining the d-axis current associated with controlling the PM electric machine comprises monitoring the d-axis current at a monitoring rate sufficient to capture dynamics in the d-axis current that may result in damage to the permanent magnet.

13. The method of claim 12, wherein monitoring the d-axis current at a monitoring rate sufficient to capture dynamics in the d-axis current that may result in damage to the permanent magnet comprises monitoring the d-axis current at no less than a 100 microsecond sampling rate.

14. The method of claim 11, wherein determining the state of health of the PM electric machine based upon the temperature-based demagnetization knee for the permanent magnet of the PM electric machine and the d-axis current comprises determining a figure of merit (FOM) in accordance with the following relationship:
$$FOM = \frac{\text{Id-min}}{\text{Id-knee}}$$
wherein
Id-min is a minimum magnitude for the d-axis current, and
Id-knee is a minimum allowable d-axis current determined based upon the magnet temperature.

15. The method of claim 14, wherein the minimum allowable d-axis current comprises a temperature-related demagnetization current knee determined based upon an intrinsic coercivity for the permanent magnet of the PM electric machine and the permanent magnet temperature.

16. The method of claim 14, wherein determining the figure of merit (FOM) in accordance with the relationship
$$FOM = \frac{\text{Id-min}}{\text{Id-knee}}$$
comprises determining the minimum magnitude for the d-axis current at a monitoring rate sufficient to capture dynamics in the d-axis current that may result in damage to the permanent magnet and determining the temperature-related demagnetization current knee at a monitoring rate that is sufficient to track expected dynamics in the permanent magnet temperature.

17. The method of claim 11, further comprising controlling operation of the PM electric machine based upon the state of health of the PM electric machine.

18. The method of claim 17, wherein controlling operation of the PM electric machine based upon the state of health of the PM electric machine comprises derating torque output of the PM electric machine.

19. The method of claim 11, further comprising:
generating a temperature-based array comprising a plurality of temperature bins associated with a plurality of temperature windows of the permanent magnet; and
determining a state of health of the PM electric machine associated with one of the temperature bins based upon the material properties of the permanent magnet and a temperature of the permanent magnet, the monitored d-axis current and the temperature of the permanent magnet.

20. The method of claim 11, further comprising:
determining a maximum total stator current vector; and
when the maximum total stator current vector amplitude is greater than zero, determining a low-confidence figure of merit (FOM) for evaluating the state of health of the PM electric machine in accordance with the following relationship:
$$FOM = \frac{Ix}{\text{Id-knee}}$$
wherein
Ix is a negative of the maximum total stator current vector amplitude, and
Id-knee is a minimum allowable d-axis current determined based upon the permanent magnet temperature.
